(19) United States
(12) Patent Application Publication
(10) Pub. No.: US 2010/0108599 A1
(43) Pub. Date: May 6, 2010

(54) FILTRATION MEMBRANE WITH TUBULAR SUPPORT

(76) Inventors: Kristof Vizvardi, Tatabanya (HU); Mailvaganam Mahendran, Mississauga (CA); Krisztina Pelle, Oroszlany (HU); Geert-Henk Koops, Burlington (CA); Andras Gyorgy Pozsgay, Oroszlany (HU)

Correspondence Address: BERESKIN & PARR (MISSISSAUGA) / GE, SCOTIA PLAZA, 40 KING STREET WEST, 40TH FLOOR, TORONTO, ON, M6H-3V2, CA

(21) Appl. No.: 12/263,725

(22) Filed: Nov. 3, 2008

(51) Int. Cl. B01D 69/10; B01D 67/00; C08J 9/00

(52) U.S. Cl. 210/500.23; 427/246; 521/50

(57) ABSTRACT

A membrane generally comprises a tubular support, and a polymeric membrane film on the support. The polymeric membrane film comprises three zones cast simultaneously from a single dope. The three zones include an inner zone on the support comprising macro-void pores, an intermediate zone on the inner zone comprising macro-void pores smaller than the macro-void pores of the inner zone, and a skin on the intermediate zone comprising pores of less than 1 micron.

### FIELD

The specification relates to filtration membranes. More specifically, the specification relates to polymeric coatings on tubular supports.

### BACKGROUND

The following is not an admission that anything discussed below is prior art or part of the common general knowledge of persons skilled in the art.

U.S. Pat. No. 5,472,607 to Mahendran et al. discloses a hollow fiber membrane comprising a tubular macroporous support coated on its outer surface with thin tubular asymmetric semipermeable film of polymer. Referring to FIG. 1, the film of polymer comprises four layers: an outer skin 35, and three layers underlying the skin. The three underlying layers include an outer layer 36, an intermediate transport layer 37, and an inner layer 38. The outer layer 36 has pores in the range from about 100 Angstroms to 2 microns, and preferably in the range from about 100 Angstrom to 1 micron. The outer layer 36 overlies the intermediate layer 37, which has pores in the range from about 0.15 microns to about 7 microns, and preferably from 0.2 microns to about 5 microns. The intermediate layer 37 overlies the inner layer 38, which has pores having diameters in the range from about 5 microns to about 300 microns, and preferably from 10 microns to 200 microns. The inner layer 38 of the film has its inner peripheral surface supported on the braid 39.

U.S. Pat. No. 7,306,105 to Shinada et al. discloses a composite porous membrane comprising a braid and a membrane material. The membrane material comprises a first porous layer which is arranged on the outer surface of the braid, and a second porous layer which is arranged on the first porous layer. The average diameter of the pores of the first porous layer is 0.2 microns to 1 micron, and at the outermost position in the first porous layer, the average diameter of the pores is in the range of 1 micron to 5 microns. The average diameter of the pores of the second porous layer is in the range of 0.1 microns to 0.8 microns, and at the outermost position in the second porous layer the average diameter of the pores is in the range of 0.8 microns to 2 microns.

U.S. Pat. No. 7,267,872 to Lee et al. discloses a braid reinforced hollow fiber membrane which includes a reinforcing material of a tubular braid and a polymer resinous thin material coated on the surface of the reinforcing material. The polymer resinous material has a skin layer with micropores having a diameter in the range from 0.01 to 1 microns, and an inner layer of a sponge structure with micropores having a diameter less than 10 microns.

### SUMMARY

The following summary is provided to introduce the reader to the more detailed discussion to follow. The summary is not intended to limit or define the claims.

A membrane will be described hereinbelow. The membrane generally comprises a tubular support, and an integrally and externally skinned polymeric membrane film on the support. The polymeric membrane film has macro-void pores with a length of 10 microns or more. The macrovoid pores are present at a density of at least 40% through at least 90% of the thickness of the membrane measured from the outside of the support to the outside of the skin.

The polymeric membrane film may comprise three zones, which are cast simultaneously from a single dope. The three zones include an inner zone on the support comprising macro-void pores, an intermediate zone on the inner zone comprising macro-void pores smaller than the macro-void pores of the inner zone, and the skin, which is on the intermediate zone and comprises pores of less than 1 micron.

The inner zone and the intermediate zone may both have a high pore density of macrovoid pores. For example, the inner zone may have a macrovoid pore density of at least 40% and the intermediate zone may have a macrovoid pore density of at least 60%. Furthermore, the macrovoid pores of the inner zone and the intermediate zone have highly porous walls. This results in high pore interconnectivity and therefore reduced transport resistance for liquids.

The inner zone may generally have a pore size of between about 40 and about 200 microns, and the intermediate zone may generally have a pore size of between about 5 and about 30 microns. By providing a zone with macrovoid pores adjacent the skin, without a zone of smaller pores therebetween, a highly open structure is formed. This results in a high liquid permeability.

### BRIEF DESCRIPTION OF THE DRAWINGS

FIG. 1 is a cross-sectional view of a prior art membrane, with greatly enlarged dimensions, illustrating the dimensional relationships of pores in the layers of the membrane;

FIG. 2 is a cross-sectional view of a membrane described hereinbelow, with greatly enlarged dimensions, illustrating the dimensional relationships of the pores in the zones of the membrane;

FIG. 3 is a cross-sectional elevational view along a longitudinal axis of a coating nozzle used to form the membrane of FIG. 2;

FIG. 4 is an electron micrograph of a membrane produced according to a process described herein;

FIG. 5 is an electron micrograph of another membrane produced according to a process described herein;

FIG. 6 is an electron micrograph of another membrane produced according to a process described herein; and

FIG. 7 is an electron micrograph of another membrane produced according to a process described herein.

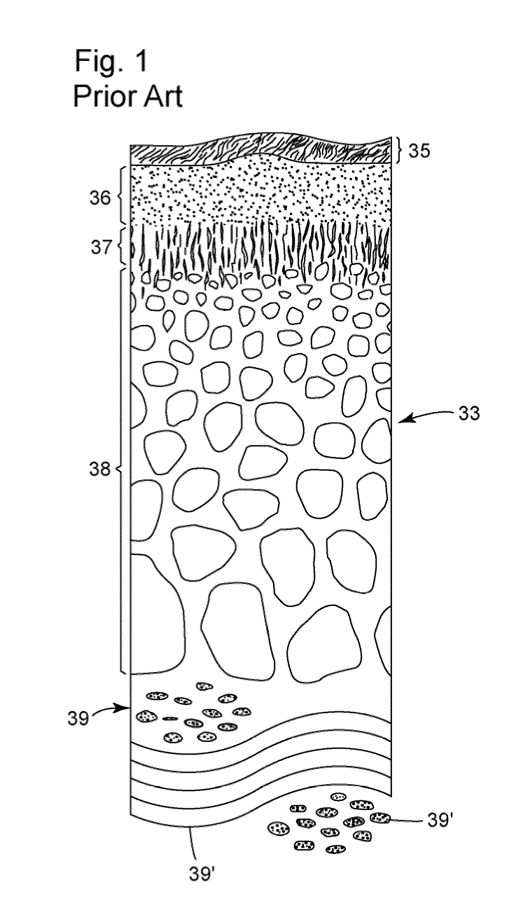

### DETAILED DESCRIPTION

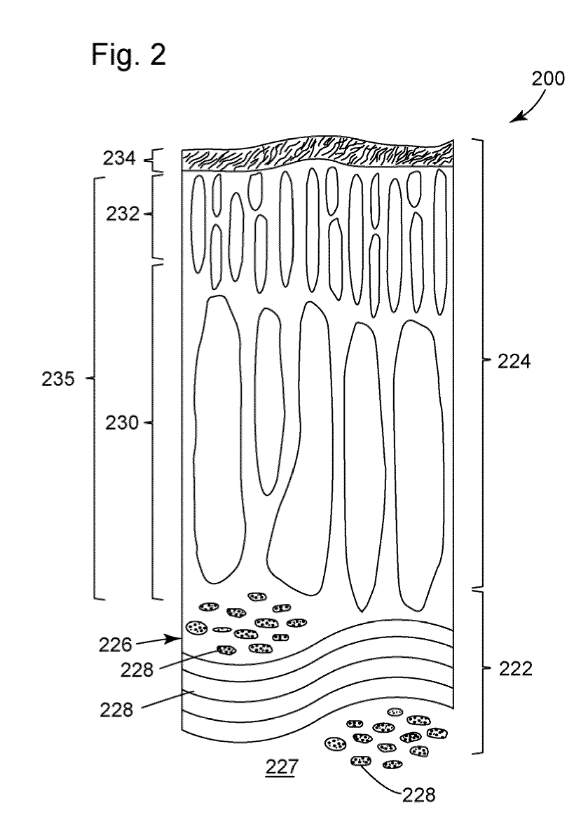

Referring to FIG. 2 there is shown in a diametrical cross-sectional view an example of a membrane 220. The membrane 220 generally comprises a tubular support 222, and a polymeric membrane film 224 on the support.

The tubular support 222 generally comprises a foraminous circumferential surface 226 defining a central longitudinal bore 227. The bore 227 of the tubular support may have a nominal inside diameter of between about 0.25 mm and about 2.3 mm. The circumferential surface may have wall thickness of between about 0.1 mm and about 0.3 mm. More specifically, the circumferential outer surface may have a wall thickness of between about 0.3 mm and about 0.5 mm.

The circumferential surface 226 may comprise braided filaments or fibers 228 insoluble in the dope to be used. As used herein, the term “braided” includes knitted, and woven. In some examples, the fibers may be braided at between about 220 and about 100 picks/25.4 mm. More specifically, the fibers may be braided at between about 5 and about 50 picks/25.4 mm. The outside diameter of the tubular support may be between 0.6 mm and about 2.5 mm.

The fibers 228 may be braided as a tube, or alternately, a pre-braided fabric may be formed into a tube. Examples of suitable fabrics for the tubular support include netting or mesh fabric such as cubicle netting 22/1000 made by Frankel Associates of New York, N.Y. of 210 denier nylon, warp-knitted by the Raschel knitting process.

In alternate examples, the circumferential surface may comprise unbraided tubular supports.

The tubular support comprises voids (not shown) which place the outside surface of the film in restricted fluid communication with the inside surface of the braid. Voids which are smaller than about 10 microns may interfere with the flux, and those larger than 100 may have the film penetrate the voids and hang too far down over the yarn forming the voids. Voids which are too large may also negate the surprising strength of the film membrane. In examples where the tubular support is braided, they may be non-uniformly shaped by the braided fibers.

The polymeric film membrane 224, is self-adherently secured to the circumferential surface 226 of the braid of woven fibers 228.

The polymeric membrane film is integrally and externally skinned. That is, the polymeric membrane film has a skin 234, which is generally a very thin dense zone of polymer formed as the dope contacts the coagulant, as will be described hereinbelow. The skin 234 may generally have a wall thickness of less than 1 micron. The pores of the skin may have a diameter of between about 10 nm and about 1 micron.

In the region 235 of the polymeric membrane film beneath the skin, the polymeric membrane film has macro-void pores with a length of 10 microns or more. The macrovoid pores are present at a density of at least 40% through at least 90% of the thickness of the membrane measured from the outside of the support to the outside of the skin.

In the example shown, the polymeric membrane film comprises three zones. The zones are cast from a single dope. The zones include an inner zone 230 on the tubular support, an intermediate zone 232 on the inner zone 230, and the skin 234, which is on the intermediate zone 232. The zones each have, in a radially inward direction from under the skin to the tubular support, progressively larger pores.

The inner zone 230 is formed on the tubular support 222, and may additionally be within the tubular support 222. The inner zone has a wall thickness of between about 50 microns and about 230 microns. The inner zone 230 has macrovoid pores, which may generally have lengths of between about 40 microns and about 200 microns. More specifically, the pores of the inner zone may have a length of between about 55 microns and about 100 microns. The macrovoid pore density of the inner zone may be between about 40% and about 90%. More specifically, the macrovoid pore density of the inner zone may be between about 50% and about 85%.

The inner zone 230 is generally sponge-like in the regions between the macrovoids. That is, the macrovoids of the inner zone 230 are interconnected by pores defined in the walls of the macrovoids. The interconnecting pores may result in a high water permeability of the membrane. The interconnecting pores may generally have a size of between about 0.1 microns and about 1 microns.

The intermediate zone 232 is on the inner zone 230, and may generally have a wall thickness of between about 5 microns and about 60 microns. The intermediate zone 232 additionally comprises macrovoid pores. The macrovoids of the intermediate zone 232 are smaller than the macrovoid pores of the inner zone. For example, the macrovoids of the intermediate zone 232 may generally have a length of between about 5 microns and about 50 microns. More specifically, the pores of the intermediate zone may have a length of between about 5 microns and about 30 microns. The macrovoid pore density of the intermediate zone 232 may be between about 60% and about 90%. More specifically, the macrovoid pore density of the intermediate zone may be between about 70% and about 90%.

In the example shown in FIG. 2, a distinction is visible between the intermediate zone and the inner zone. However, in other examples, the membrane may not comprise a readily distinguishable intermediate zone and inner zone. That is, the region 235 beneath the skin may comprise or appear as a single zone.

The overall wall thickness of the polymeric membrane film 224 may be between about 50 microns and about 230 microns. More specifically, the overall wall thickness may be between about 100 microns and about 160 microns.

The method for producing the membrane generally comprises casting the membrane film onto the support simultaneously using a single dope. The dope generally comprises a film-forming polymer, and a solvent for the polymer. In order to produce a polymer film comprising the three zones described hereinabove, the film-forming polymer is present in the dope in a relatively low concentration. For example, the dope may comprise between about 10 wt. % and about 25 wt. % of film forming polymer. More specifically, the dope may comprise between about 12 wt. % and about 20 wt. % of film-forming polymer.

Suitable polymers from which the film is formed include for example, polysulfone, polyethersulfone, polyether ether ketone, polyvinyl chloride (PVC), polyvinylidene dichloride (PVDC), chlorinated polyvinylchloride (CPVC), polyvinylidene difluoride (PVDF), polyvinylfluoride (PVF), other fluoro polymers or co-polymers, cellulose acetate, cellulose nitrate, cellulose triacetate, cellulose butyrate, polyacryloniyrile, sulfonated polyether ether ketone, sulfonated polysulfone, sulfonated polyethersulfone, polyimides, polyamides, polymethyl methacrylate, polystyrene, or any blend or co-polymers of the above.

Solvents for most commonly used for polymers include Pentane, Hexane, Cyclohexane, Ethyl acetate, Dichloroethane, Chloroform, Dimethylformamide (DMF), Dimethylacetamide (DMAc), N-Methylpyrrolidone (NMP), N-Ethylpyrrolidone (NET), Formamide, Triethylphosphate (TEP), γ-Butyrolactone, ε-Caprolactam, Dimethylsulfoxide (DMSO), Tetrahydrofuran (THF), Acetone, Pyperidine, Imidazole, and Sulfuric acid.

Furthermore, the dope generally comprises no or very small amounts of non-solvent and/or weak non-solvent. For example, the dope may comprise between about 0 wt. % and about 20 wt. % of non-solvent and/or weak non-solvent. More specifically, the dope may comprise between about 0 wt. % and about 10 wt. % of non-solvent and/or weak non-solvent. Suitable non-solvents or weak non-solvents include polyethylene glycol, glycerin, water, methanol, ethanol, iso-propanol, butanol, 1,2, propanediol, 1,3 butenediol, acetic acid, propionic acid, butyric acid, oxalic acid, ethylene glycol, dietheylene glycol, tri-ethylene glycol, tetra-ethylene glycol, 2-methyl-2,4-pentanediol, 1,2,6-hexanetriol, di-ethylene glycol monomethylether, and di-ethylene glycol monoethylether.

In addition, in order to obtain a high surface porosity and membrane hydrophilicity a certain amount of hydrophilic polymeric and/or relatively low molecular weight hydrophilic additive may be required. On one hand, a good balance between molecular weight and concentration is necessary; high concentration results in smaller and less macrovoids, too little results in too low surface porosity and lack of hydrophilicity. On the other hand, the combination of membrane casting parameters is also influential in engineering the right amount and volume of macrovoids and surface porosity leading to differently permeable membranes. Higher casting temperatures result in lower permeabilities and higher mechanical strength, while lower ones give higher permeable, but weaker membranes as shown in the examples.

In some examples, the dope may comprise between about 0 wt. % and about 15 wt. % of hydrophilic additives. More specifically, the dope may comprise between about 1 wt. % and about 10 wt. % of hydrophilic additives. Suitable hydrophilic additives include polyvinyl pyrolidone (PVP), LiCl, polyvinylalcohol, polyvinylacetate, hydrolyzed or partly hydrolyzed polyvinyl acetate, hydrolyzed or partly hydrolyzed polyvinyl alcohol, polyethyleneoxide, polyethylene glycol, branched polyethylene glycol, polyethylene oxide-polypropylene oxide-polyethylene oxide copolymers, polyvinyl pyrolidone-co-vinylacetate, cellulose acetate, cellulose esters, and hydroxypropylcellulose.

The process for producing the membrane generally comprises introducing the dope into a coating nozzle at a flow rate correlatable to the speed with which the tubular braid is advanced through a rounding orifice of the coating nozzle such that only as much dope as can be supported on the outer portion of the tubular support is deposited on it.

In order to prevent the voids of the tubular support from interfering with the uniformity of the film, the speed with which the tubular support is advanced may be less than that at which the voids in the tubular support are distorted more than 50%. As the tubular support is drawn through the rounding orifice of the coating nozzle, the support's slightly asymmetric cross-section may be restored to circularity, and this circularity may be maintained when the dope is coagulated to form the film membrane.

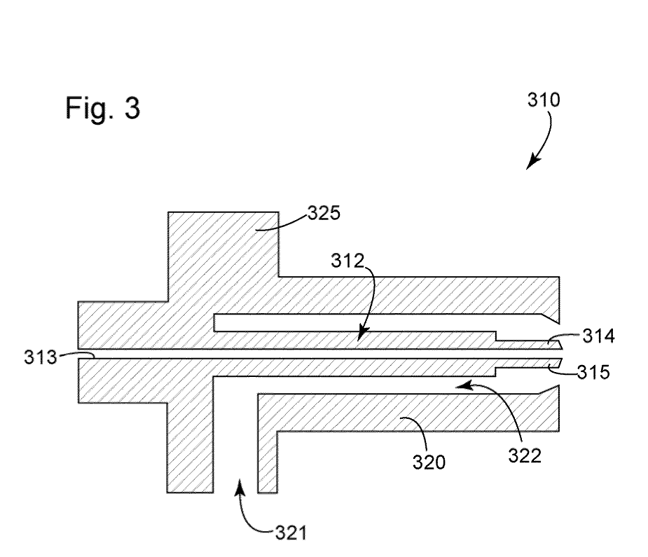

Referring to FIG. 3 a cross-sectional view of an example of a coating nozzle 310 usable for forming a polymeric membrane film on a tubular support is shown. Nozzle 310 is configured to limit the amount of dope passing through the nozzle, and to meter the correct amount of dope over the surface and distribute the metered amount uniformly over the surface of the tubular support (not shown) as it is drawn longitudinally axially through the nozzle.

The nozzle 310 comprises an inner barrel 312 having an internal bore 313 through which the tubular support is advanced into an axial bore 314 of a nipple 315. The nipple 315 may be integral with the barrel 312, or may be threadedly secured in an end of the barrel 312. The bore 314 provides a rounding orifice to help the tubular support to acquire a circular cross-section before it is coated with dope. The rounding orifice 314 may have a diameter in the range from about 1% to 10% less than the nominal diameter of the tubular support. The barrel 312 with the nipple 315 is inserted in an outer barrel member 320 having a cylindrical base 325. The outer barrel 320 is provided with an inner axial chamber 322. The chamber 322 may be stepped, and have a larger bore and a smaller bore near the end of the bore (not shown). As the tubular support is advanced out of the bore 314, it is coated with polymer

The base 325 is provided with a lower port 321 in open communication with the chamber 322 so that dope introduced into the port 321 can flow into the chamber 322, and travel longitudinally axially in the direction in which the braid is drawn through the bore 313

To draw the tubular support through the bore 314 a longitudinal tension may be maintained on the tubular support of at least 10 cN-g, but not enough to distort the voids in the tubular support so badly that they cannot return to an equilibrium state as they are being coated with dope. Because the tubular support is not impregnated with the viscous polymer solution, only the outer surface of the tubular support is contacted with the dope so as to provide the tubular support with a dope- and polymer-coated outer surface.

After the dope-coated tubular support leaves the sizing orifice, it is led into a coagulating bath, typically under and over a series of rolls, so that the liquid coagulant held in the bath contacts the entire circumferential surface of the coated tubular support. Upon contacting the coagulant, the dope coagulates, yielding the desired thin film membrane. The bore of the fiber contains air at atmospheric pressure.

It will be appreciated that features which are described in the context of separate examples may also be provided in any suitable combination. Conversely features which are described in combination in the context of a single example may also be provided separately or in any suitable sub-combination. Further, although one or more inventions have been described in conjunction with specific examples or process or apparatus, many alternatives, modifications and variations may fall within the scope of the appended claims. While the examples specifically described above, collectively and including possible combinations or sub-combinations of the features of the examples, are intended to provide at least one example of an embodiment of each claim, it is possible that a particular claim does not read on one or more of the examples and that one or more of the examples are not within a particular, or even any, claim. Accordingly, the claims should not be interpreted so as to cover or be restricted to all of the examples, or even to any one of them.

### EXAMPLES

### Example 1

A dope was prepared by mixing 16% polyvinylidene difluoride, 5% polyvinylpyrrolidone, 1% polyvinylacetate-polyvinylalcohol mixture and 2% aluminium oxide suspension in 71.5% N-methyl pyrrolidone. After degassing at elevated temperature and reduced pressure, the membrane casting solution was introduced to a spinneret having two orifices. Of the two orifices, the inner one served to forward the hollow braid, and the outer one served to forward the casting solution onto the braid. The coated braid was led through an air-gap of 50 mm entering the precipitation bath 50° C.

The resulting hollow fiber supported membrane having a layer thickness between 100 and 160 μm was rinsed at elevated temperature and collected for characterization.

After rinsing in hypochlorite solution the clean water permeability was 15 gfd/psi and the polyethyleneoxide (Mw=200 k) retention was 46%.

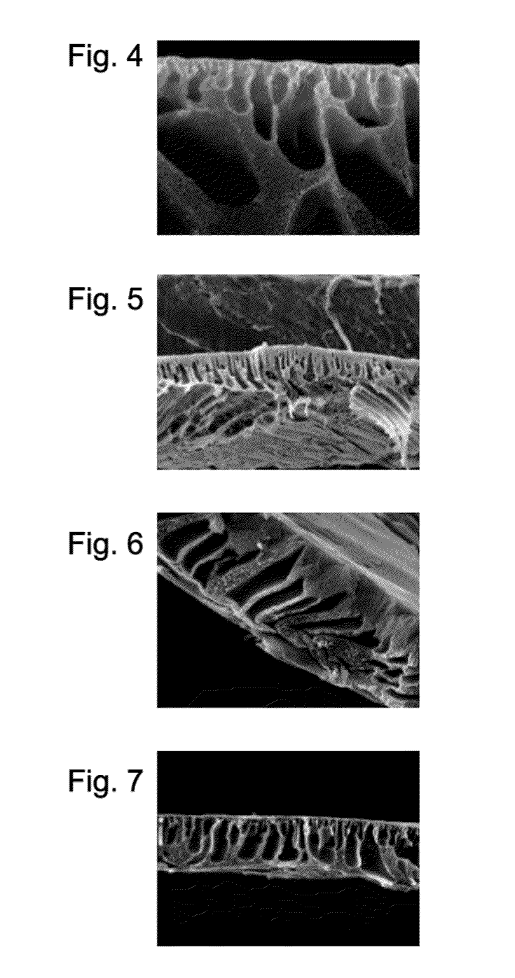

An electron micrograph of the resulting membrane is shown in FIG. 4.

### Example 2

A dope was prepared mixing 18% polysulfone, 5% polyvinylpyrrolidone, 4% sulfuric acid and 1% water in 72% N-methyl pyrrolidone. After degassing at elevated temperature and reduced pressure, the membrane casting solution was introduced to a spinneret having two orifices. Of the two orifices, the inner one served to forward the hollow braid, and the outer one served to forward the casting solution onto the braid. The coated braid was led through an air-gap of 50 mm entering the precipitation bath 60° C.

The resulting hollow fiber supported membrane having a layer thickness between 100 and 160 μm was rinsed at elevated temperature and collected for characterization.

After rinsing in hypochlorite solution the clean water permeability was 10 gfd/psi and the polyethyleneoxide (Mw=200 k) retention was 86%.

An electron micrograph of the resulting membrane is shown in FIG. 5.

### Example 3

A dope was prepared mixing 16% polysulfone, 10% polyvinylpyrrolidone, 4% lithium chloride and 2% water in 68% N-methyl pyrrolidone. After degassing at elevated temperature and reduced pressure, the dope was introduced to a spinneret having two orifices. Of the two orifices, the inner one served to forward the hollow braid and the outer one served to forward the casting solution onto the braid. The coated braid was led through an air-gap of 50 mm entering the precipitation bath 55° C.

The resulting hollow fiber supported membrane having a layer thickness between 100 and 160 μm was rinsed at elevated temperature and collected for characterization.

After rinsing in hypochlorite solution the clean water permeability was 32 gfd/psi and the polyethyleneoxide (Mw=200 k) retention was 65%.

An electron micrograph of the resulting membrane is shown in FIG. 6.

### Example 4

The membrane casting solution was prepared mixing 14% polyvinylidene difluoride, 6% polyvinylpyrrolidone and 1% water in 79% N-methyl pyrrolidone. After degassing at elevated temperature and reduced pressure, the membrane casting solution was introduced to a spinneret having two orifices. Of the two orifices, the inner one served to forward the hollow braid and the outer one served to forward the casting solution onto the braid. The coated braid was led through an air-gap of 50 mm entering the precipitation bath 45° C.

The resulting hollow fiber supported membrane having a layer thickness between 100 and 160 μm was rinsed at elevated temperature and collected for characterization.

After rinsing in hypochlorite solution the clean water permeability was 60 gfd/psi and the polyethyleneoxide (Mw=200 k) retention was 66%.

An electron micrograph of the resulting membrane is shown in FIG. 7.

1. A membrane comprising:
a) a tubular support; and
b) a polymeric film on the support, the polymeric film comprising three zones cast simultaneously from a single dope, the three zones comprising:
i) an inner zone on the support comprising macro-void pores;
ii) an intermediate zone on the inner zone comprising macro-void pores smaller than the macro-void pores of the inner zone; and
iii) a skin on the intermediate zone comprising pores of less than 1 micron.

2. The membrane of claim 1, wherein the inner zone has a macrovoid pore density of 40-90%.

3. The membrane of any one of claim 1, wherein the intermediate zone has a macrovoid pore density of 60-90%.

4. The membrane of any one of claim 1, wherein the inner zone is additionally in the support.

5. The membrane of any one of claim 1, wherein the inner zone has a pore size of between about 40 and about 200 microns.

6. The membrane of any one of claim 1, wherein the intermediate zone has a pore size of between about 5 and about 30 microns.

7. The membrane of any one of claim 1, wherein the polymeric coating has a thickness of between about 50 microns and 230 microns.

8. The membrane of any one of claim 1, wherein the polymeric coating has a thickness of between about 100 microns and 160 microns.

9. The membrane of any one of claim 1, wherein the macrovoids of the inner zone are connected by pores having a size of between about 0.1 microns to 01 microns.

10. The membrane of any one of claim 1, wherein the polymeric coating is selected from the group consisting of polysulfone, polyethersulfone, polyether ether ketone, polyvinyl chloride, polyvinylidene dichloride, chlorinated polyvinylchloride, polyvinylidene difluoride, polyvinylfluoride, other fluoro polymers or co-polymers, cellulose acetate, cellulose nitrate, cellulose triacetate, cellulose butyrate, polyacryloniyrile, sulfonated polyether ether ketone, sulfonated polysulfone, sulfonated polyethersulfone, polyimides, polyamides, polymethyl methacrylate, and polystyrene.

11. The membrane of any one of claim 1, wherein the dope comprises a solvent and a film forming polymer having a concentration of between 10 wt. % and 25 wt. %

12. The membrane of any one of claim 1, wherein the dope further comprises at least one of a non-solvent and/or a weak non-solvent having a concentration of between 0 wt. % and 20 wt. %

13. The membrane of any one of claim 1, wherein the dope further comprises a hydrophilic polymer additive having a concentration of between 0 wt. % and 15 wt. %.

14. A casting dope for producing a polymeric membrane film on a tubular support, the casting dope comprising:
a) a solvent; and
b) a film forming polymer soluble in the solvent and having a concentration of between 10 wt. % and 25 wt. %

15. The casting dope of claim 14, further comprising at least one of a non-solvent and/or a weak non-solvent having a concentration of between 0 wt. % and 20 wt. %.

16. The casting dope of any of claim 14, further comprising a hydrophilic polymer additive having a concentration of between 0 wt. % and 15 wt. %.

17. A process for casting a dope onto a tubular support to produce a polymeric membrane film on the tubular support, the process comprising:
a) providing a dope according to any of claims 14 to 16 comprising a solvent; and a film forming polymer soluble in the solvent and having a concentration of between 10 wt. % and 25 wt. %.
b) advancing the tubular support through a rounding orifice of a coating nozzle;
c) introducing the dope into a coating nozzle at a flow rate correlatable to a speed at which the tubular support is advanced through the rounding orifice of the coating nozzle to form a dope-coated tubular support; and
d) leading the dope-coated tubular support into a coagulating bath.

18. A membrane comprising:
a) a tubular support; and
b) an integrally and externally skinned polymeric membrane film on the support, the polymeric membrane film having macro-void pores with a length of 10 microns or more present at a density of at least 40% through at least 90% of the thickness of the membrane measured from the outside of the support to the outside of the skin.
